(19) United States
(12) Patent Application Publication
(10) Pub. No.: US 2013/0143672 A1
(43) Pub. Date: Jun. 6, 2013

(54) GAME SYSTEM AND METHOD FOR CONTROLLING BROWSE OF GAME-PLAY CONTENT THEREOF

(71) Applicants: Shinya Azuma, Minato-ku (JP); Michiaki Imachi, Minato-ku (JP)

(72) Inventors: Shinya Azuma, Minato-ku (JP); Michiaki Imachi, Minato-ku (JP)

(21) Appl. No.: 13/816,080

(22) PCT Filed: Aug. 10, 2011
(86) PCT No.: PCT/JP2011/068292

§ 371 Date: Feb. 8, 2013

(30) Foreign Application Priority Data
Aug. 12, 2010 (JP) 2010-181034

(51) Int. Cl. A63F 13/12

(52) U.S. Cl. 463/42

(57) ABSTRACT

There is provided a game system where a game apparatus and a user terminal can use a storage area in the server apparatus in a rational manner. A game-machine storage area and a browse storage area are provided in a server. By a user of game machine, a game-play data is stored into the area. The game-play data stored in the area are presented to a user of user terminal, who is requested to select game-play data, and the selected game-play data is stored into the area. The game-play data stored in the area are presented to the user of user terminal, who is requested to select game-play data, and the selected game-play data is provided to the user terminal. Then, the user of user terminal is allowed to browse the selected game-play data.

### TECHNICAL FIELD

The present invention relates to a game system and the like which is configured to store a game-play data set in a server apparatus, the game-play data set having at least one part of game-play content in a game played at a game apparatus, and, by referring to the game-play data set from a user terminal apparatus, make it possible to browse the game-play content of the game.

### BACKGROUND ART

As a game system using a network, there is proposed a game system which is configured to record in a game-play data set at least one part of game-play content of a game played at a game apparatus, store the game-play data in a server apparatus, and thereby provide browse of game-play content of past game when a user terminal apparatus such as a personal computer (hereinafter, called a PC in an abbreviated manner) accesses the server apparatus (for example, PTL 1 and PTL 2). Although the term “browse” should be used for game-play content which is recorded in the game-play data set, hereinafter, a representation “to browse the game-play data set” is sometimes used for conciseness.

Patent Literature 1: JP-A-2003-360935 and Patent Literature 2: JP-A-2004-313402.

### SUMMARY OF INVENTION

### Technical Problem

With respect to a conventional game system, in a storage device of a server apparatus, a storage area where game-play data sets are written by following indications from a game apparatus and a storage area for game-play data to be browsed at a user terminal apparatus are not separated from each other, and a same area is shared by the game apparatus and the user terminal apparatus. Accordingly, it is impossible to use different storage area depending on which uses the area, the game apparatus or the user terminal, and this could provoke kind of inconvenience.

For example, in a case that the game apparatus and the server apparatus frequently access each other not only for transmitting and receiving the game-play data set, but also for various kinds of processes necessary to progress a game, if the storage area for game-play data from the game apparatus is extended unconsideredly, process for storing the game-play data set occurs frequently, and this makes the load on the server apparatus increase notably. On the other hand, in a case that the access from the user terminal apparatus to the server apparatus is limited to the access relating to browse of the game-play data set, even if the storage area for the user terminal apparatus is extended, the load on the server apparatus does not increase very much. However, if the storage area is limited in consideration of the access from the game apparatus, service which could be provided to the user terminal apparatus becomes limited. Alternatively, in a case that there is a difference in load ability between the server apparatus and the user terminal apparatus, if the capacity of storage area used for browsing service of game-play data is set appropriately only to one of the apparatuses, in the other one of the apparatuses, the storage capacity of data is too much or too small for its load ability. Therefore, it is impossible to provide appropriate service to both of the game apparatus and the user terminal apparatus. Further, with respect to management of data, inconvenient situation could occur. For example, in a case the storage area for game-play data is shared, problems such as a conflict because of same timing access or incongruous of data could occur. Namely, the problem could occur that data browsed by one apparatus is updated by the other apparatus, and thereby, the data browsed by the one apparatus becomes not the latest data. Or, restriction at the moment of relocating data might get bigger.

Then, the aim of the present invention is providing a game system and the like where the game apparatus and the user terminal can use the storage area of game-play data in the server apparatus in a rational manner, relating to browse of game-play content.

### Solution to Problem

A game system as one aspect of the present invention is a game system using a server apparatus connected to a game apparatus via a network, allowing a user to play a predetermined game, recording at least one part of game-play content of the game in a game-play data set to store the game-play data set in the server apparatus, and enabling the user to browse the game-play content corresponding to the game-play data set at a user terminal apparatus connected to the server apparatus via the network, the game system comprising: a game-play storage device provided to the server apparatus, and adapted and configured to have a first storage area set as a writing area for the game apparatus and a second storage area set as a writing area for the user terminal apparatus; a first game-play data storing device adapted and configured to store the game-play data set into the first storage area by following an indication from a user of the game apparatus;

a candidate for browse selecting device adapted and configured to present a list of game-play data sets stored in the first storage area to a user of the user terminal apparatus, and allow the user to select a game-play data set to be a candidate for browse from the game-play data sets stored in the first storage area; a second game-play data storing device adapted and configured to store the game-play data set selected as the candidate for browse into the second storage area; a browse target for terminal selecting device adapted and configured to present a list of game-play data sets stored in the second storage area to the user of the user terminal apparatus, and allow the user to select a game-play data set to be a browse target from the game-play data sets stored in the second storage area; and a browse for terminal implementing device adapted and configured to provide the game-play data set selected as the browse target to the user terminal apparatus, and allow the user of the user terminal apparatus to browse the game-play content corresponding to the game-play data set provided.

According to the present invention, while a game-play data set where game-play content in the game apparatus is recorded is stored into the first storage area of the game-play data storage device by following the indication of a user from the game apparatus, the list of game-play data sets stored in the first storage area is presented to a user of the user terminal apparatus, and a game-play data set selected by the user as a candidate for browse is stored into the second storage area. When the user selects a browse target from the game-play data sets as the candidates for browse stored in the second storage area, a user can browse at the user terminal apparatus, the game-play content corresponding to the game-play data set selected. As the first storage area which is an writing area for the game apparatus is provided so as to be independent of the second storage area which is an writing area for the user terminal, it is possible to use different storage areas according to a utilization purpose of each of the game apparatus and the user terminal apparatus, in such a way that while the first storage area is used as a storage place of game-play data sets for indications from the game apparatus, the second storage device is used as a storage place of the game-play data sets to be browsed at the user terminal apparatus. Thereby, it is possible to eliminate or suppress inconvenient which could occur caused by using a shared storage area.

For example, it is possible to set the storage capacity of the second storage area depending on a situation of access from the user terminal apparatus to the server apparatus, while the storage capacity of the first storage area is set depending on a situation of access from the game apparatus to the server apparatus. Thereby, with respect to the browse of game-play data, it is possible to provide service appropriate for a load on the system to both of the game apparatus and the user terminal apparatus.

As a game-play data set is stored into each of the first storage area and the second storage area, it is possible to implement appropriately for the game apparatus, such data management of the first storage area as a game-play data set is stored newly, updated, and deleted, and implement appropriately for the user terminal apparatus such data management of the second storage area as a game-play data set is stored newly, updated, and deleted. Thereby, it is possible to avoid data competition or data inconsistency which occurs because of writing access to the same storage area from both apparatuses. Further, even when data in one storage area is moved to another area, or one storage area is changed such as expanded or downscaled, the influent is not exerted on the data in the other storage area. Thereby, it is possible to reduce the restriction with respect to a change or maintenance of system.

As one embodiment of the present invention, the candidate for browse selecting device may be adapted and configured to further present a list of game-play data sets stored in the second storage area to the user, and allow the user to select the game-play data set to be the candidate for browse. Thereby, when selecting a game-play data set which should be a candidate for browse, while referring to the list of game-play data sets stored in each of the first storage area and the second storage area, a user can specify a game-play data set which has been stored in the first storage area and not yet been stored in the second storage area, and select the specified game-play data set as the candidate for browse.

As one embodiment of the present invention, the game system may further comprise: an identification information generating device adapted and configured to generate identification information for identifying the content of the game-play data set; a first identification information storing device adapted and configured to, caused by storing the game-play data set into the first storage area, store the identification information corresponding to the game-play data set into the first storage area; and a second identification information storing device adapted and configured to, caused by storing the game-play data set selected as the candidate for browse into the second storage area, store the identification information corresponding to the game-play data set into the second storage area. Thereby, by using the identification information, it is possible to generate easily the list of game-play data sets stored in each of the first storage area and the second storage area.

The candidate for browse selecting device may be adapted and configured to provide the identification information stored in the first storage area to the user terminal apparatus, and present the list of game-play data sets stored in the first storage area to the user of the user terminal apparatus. In this case, it is possible to present the list of game-play data sets more easily and promptly than a case that the list is generated by analyzing the game-play data sets stored in the first storage area.

Further, the second identification information storage device may be adapted and configured to obtain from the use terminal and store into the second storage area, the identification information corresponding to the game-play data set selected as the candidate for browse. When the candidate for browse is selected, the identification information stored in the first storage area is provided to the user terminal apparatus. Accordingly, in a case the server apparatus obtains from the user terminal apparatus the identification information corresponding to the game-play data set selected as the candidate for browse, it is not necessary to implement a processing that the server apparatus extracts the identification information corresponding to the game-play data set selected as the candidate for browse from the first storage area, and it is possible to reduce the load on the server apparatus.

The candidate for browse selecting device may be adapted and configured to further present to the user a list of game-play data sets stored in the second storage area by providing the identification information stored in the second storage area to the user terminal apparatus, and allow the user to select the game-play data set to be the candidate for browse. Thereby, it is possible to, when the game-play data set to be the candidate for browse is selected, present to the user of the user terminal apparatus, the list of the game-play data sets stored in each of the first storage area and the second storage area based on the identification information stored in each of the first storage area and the second storage area. By referring to those lists, the user can specify game-play data set which has been stored in the first storage area and has not yet been stored in the second storage area, and select the specified game-play data set as the candidate for browse.

The candidate for browse selecting device may be adapted and configured to further present to the user, information for the user to specify a game-play data set which is stored in the first storage area and not stored in the second storage area, based on the identification information stored in the first storage area and the identification information stored in the second storage area. If the identification information of each storage area is compared to each other, it is possible to determine the game-play data sets which have been stored in the first storage area and have not yet been stored in the second storage area. By presenting the determination result to the user, the user can specify further easily the game-play data set which should be stored in the second storage area as the candidate for browse.

As one embodiment of the present invention, the candidate for browse selecting device may be adapted and configured to provide the game-play data sets stored in the first storage area to the user terminal apparatus, and the second game-play data storing device may be adapted and configured to obtain from the user terminal apparatus and store into the second storage area the game-play data set selected as the candidate for browse. According to this embodiment, when the game-play data set to be the candidate for browse is selected, the game-play data sets stored in the first storage area have been provided to the user terminal apparatus. Accordingly, it is not necessary to implement after the candidate for browse is selected, a processing that the server apparatus extracts the selected game-play data set. Therefore, it is possible to reduce the load on the server apparatus.

As one example of embodiment where the identification information is used, the game system may further comprise a deletion data selecting device adapted and configured to present a list of game-play data sets stored in the first storage area to the user of the game apparatus, based on the identification information stored in the first storage area, and allow the user to select a game-play data set to be deleted from the first storage area in exchange of a storage of a new game-play data set by the first game-play data storing device, and the first game-play data storing device may be adapted and configured to store the new game-play data set into the first storage area in exchange of a deletion of the game-play data set selected by the deletion data selecting device. Thereby, when the game-play data set is stored in the first storage area, it is possible to make the user of the game apparatus recognize the game-play data sets already stored in the first storage area. This could provide a reference for the user in a case of selecting game-play data set to be deleted in exchange of a storage of new game-play data set. For example, in a case that the storage capacity of the first storage area is deficient, or a game-play data set which becomes unnecessary remains in the first storage area, the user may select a game-play data set to be deleted and indicate a storage of new game-play data set, referring to the list of game-play data sets.

Further, the deletion data selecting device may be adapted and configured to further present to the user, information for the user to specify a game-play data set which is stored in the first storage area and not stored in the second storage area, based on the identification information stored in the first storage area and the identification information stored in the second storage area. Thereby, provided is a situation that the user can specify further easily the game-play data set to be deleted.

As one embodiment of the present invention, the game-play data set may be generated in the game apparatus, and the first game-play data storing device may be adapted and configured to obtain the game-play data set from the game apparatus and store the game-play data set into the first storage area. Thereby, it is possible to provide a situation that first, a new game-play data set generated in the game apparatus gets stored into the first storage area, and after that, by an access from the user terminal apparatus, the game-play data set the user wants gets stored into the second storage area to be used for its browse.

As one embodiment of the present invention, the game system may comprise: a browse target for game apparatus selecting device adapted and configured to present a list of game-play data sets stored in the first storage area to the user of the game apparatus, and allow the user to select a game-play data set to be the browse target from the game-play data sets stored in the first storage area; and a browse for game apparatus implementing device adapted and configured to allow the user of the game apparatus to browse the game-play content corresponding to the game-play data set selected as the browse target. Thereby, it is possible to browse at the game apparatus the game-play content correspondent to the game-play data set stored in the first storage area.

As one embodiment of the present invention, the game apparatus may be configured as a game machine for business use which allows game-play in exchange of a payment of game-play fee. Thereby, it is possible to configure service using the first storage area appropriately for an individual situation of each game machine for business use. Further, a storage capacity of the first storage area for the game-play data set may be smaller than a storage capacity of the second storage area for the game-play data set. In a case that the game apparatus is a game machine for business use, a lot of game machines for business use access to the server apparatus repeatedly on a daily basis. Therefore, it is preferable that by restricting the storage capacity of game-play data sets stored in the first storage area, the load on the server apparatus relating to the browse of game-play data set of the first storage area is reduced. On the other hand, for the user terminal apparatus the access from which is limited, by enabling the second storage area to store more game-play data sets, service relating to the browse could improve.

In a case that the game machine is a game machine for business use, the game system may further comprise: an electronic fee collection device adapted and configured to collect a fee by exchange of electronic payment information; and a storage controlling device adapted and configured to, for a storage of the game-play data set into the second storage area, request the user to pay a predetermined fee through the electronic fee collection device, and permit the storage of the game-play data set into the second storage area in a case that the predetermined fee is paid, and restrict the storage of the game-play data set into the second storage area in a case that the predetermined fee is not paid. Thereby, by providing the browse of game-play content as service with fee, it is possible to maintain the consistency with the collection of game-play fee. While, by collecting the counter value for the browse through a network, it is possible for a user to use easily the browse service at the user terminal apparatus. Further, as the fee collection by exchange of electronic payment information is capable of accepting small value payment, flexible fee setting is provided.

Another aspect of the present invention is a method for controlling browse of game-play content being applied to a game system using a server apparatus connected to a game apparatus via a network, allowing a user to play a predetermined game, recording at least one part of game-play content of the game in a game-play data set to store the game-play data set in the server apparatus, and enabling the user to browse the game-play content corresponding to the game-play data set at a user terminal apparatus connected to the server apparatus via the network, the method including the following steps: providing a game-play storage device to the server apparatus, and adapted and configured to have a first storage area set as a writing area for the game apparatus and a second storage area set as a writing area for the user terminal apparatus; storing the game-play data set into the first storage area by following an indication from a user of the game apparatus; presenting a list of game-play data sets stored in the first storage area to a user of the user terminal apparatus, and allowing the user to select a game-play data set to be a candidate for browse from the game-play data sets stored in the first storage area; storing the game-play data set selected as the candidate for browse into the second storage area; presenting a list of game-play data sets stored in the second storage area to the user of the user terminal apparatus, and allowing the user to select a game-play data set to be a browse target from the game-play data sets stored in the second storage area; and providing the game-play data set selected as the browse target to the user terminal apparatus, and allowing the user of the user terminal apparatus to browse the game-play content corresponding to the game-play data set provided. According to the method for controlling browse of the present invention, for the same reason as the above mentioned game system, it is possible to perform such effects as appropriate service is provided to each of the game apparatus and the user terminal apparatus.

### Effects of Invention

As mentioned above, according to the present invention, while a game-play data set where a game-play content in the game apparatus is recorded is stored in the first storage area in the game-play data storage device by following the indication of user from the game apparatus, the list of game-play data sets stored in the first storage area is presented to a user of the user terminal apparatus, and a game-play data set selected by the user as a candidate for browse is stored in the second storage area. It is possible to use different storage areas according to a utilization purpose of each of the game apparatus and the user terminal apparatus, in such a way that while the first storage area is used as a storage place of the game-play data sets for indications from the game apparatus, the second storage device is used as a storage place of the game-play data sets to be browsed at the user terminal apparatus. Thereby, it is possible to provide, with respect to the browse of game-play data, service appropriate for the load on the system to each of the game apparatus and the user terminal apparatus, and it is possible to avoid data competition which occurs because of writing access to the same storage area from both apparatuses. Further, even when data in one storage area is moved to another area, or one storage area is changed such as expanded or downscaled, the influent is not exerted on the data in the other storage area. Thereby, it is possible to reduce the restriction with respect to a change or maintenance of system.

### BRIEF DESCRIPTION OF DRAWINGS

FIG. 1: A diagram showing an outline of game system according to one embodiment of the present invention.

FIG. 2: A functional block diagram of the game system shown in FIG. 1.

FIG. 3: A diagram showing one example of game image.

FIG. 4: A diagram showing a relation between a game machine and a user terminal apparatus, and data stored in a center server.

FIG. 5: A flow chart showing a game record management in game machine routine executed by a control unit of the game machine, and a game record management for game machine routine executed by a control unit of the center server corresponding to the game record management in game machine routine.

FIG. 6: A diagram showing one example of game-record list image displayed at the game machine at the moment of storing a game record data set.

FIG. 7A: A flow chart showing a game record management in terminal routine executed by a control unit of a user terminal.

FIG. 7B: A flow chart showing a game record management for terminal routine executed by the control unit of the center server corresponding to the routine shown in FIG. 7A.

FIG. 8: A diagram showing one example of game-record list image displayed at the user terminal.

FIG. 9: A diagram showing other example of game-record list image displayed at the user terminal.

### DESCRIPTION OF EMBODIMENTS

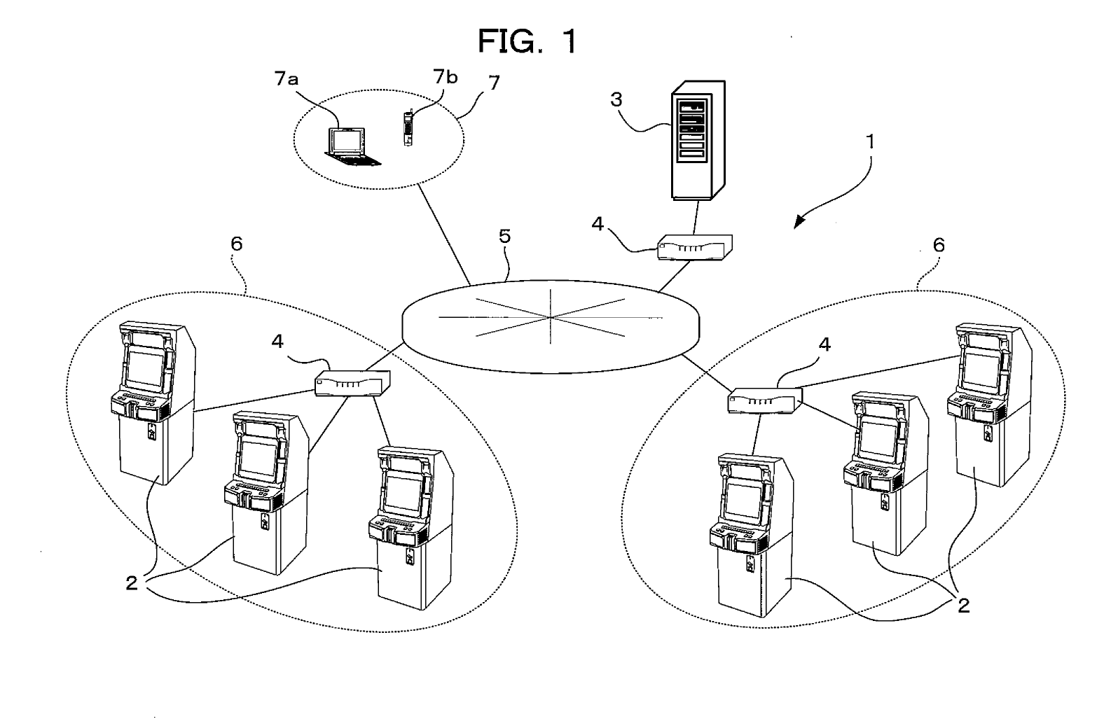

FIG. 1 shows a game system according to one embodiment of the present invention. The game system 1 of the preset invention is configured so that a player of one game machine 2 plays Japanese chess with a player of another game machine 2, and stores game record data sets (corresponding to game-play data sets) in which battle content is recorded from the start to end of the game-play in a server apparatus, and the player can browse past game-play content by referring to the game record data set. In a game system 1, a plurality of game machines 2 as game apparatuses and a center server 3 as a server apparatus are connected to a network 5 via router 4 respectively. The center server 3 is not only one example configured by one physical apparatus. A logical center server 3 may be configured by plural servers of physical apparatuses. Further, one game machine 2 may be also used as the center server 3. The network 5 realizes a network communication using the TCP/IP protocol, and typically, the internet is applied to the network 5. Each of the game machines 2 is configured as a commercial (or business-use) game machine which collects a game-play fee as a counter value of a game. An appropriate number of game machines are installed in each commercial facility such as a store 6. Each router 4 is installed in a state of being associated with each store 6 and the center server 3, and the game machines 2 in the same store 6 share the same router 4 to connect to the network 5. A local server may be installed between the game machine 2 and the router 4 of the store 6 so that the game machine 2 connects communicably to the center server 3 via the local server.

The center server 3 is installed by an operator of the game system 1, and provides various kinds of services via the network 5 to the game machine 2 or a user (sometimes called a player) of the game machine 2. As one example, The center server 3 provides the following services: service of updating a game program or data via the game machine; service of verifying the user of the game machine 2 and storing player data including user's name, his/her game score and the like in the center server 3; and service of combining users when the users battles each other via the network 5. The above mentioned game record data set constitutes a part of the player data. The details of player data will be described later.

To each of the game machine 2 and the center server 3, a unique IP address is given for identifying each of the game machine 2 and the center server 3 on the network 5. In the communication between the game machines or between the game machine 2 and the center server 3, a communication partner is specified by using the IP address. In a case that the network 5 has an open nature like the internet, a static address unique on the network is given to each router 4. A private address is set as the IP address for the game machine 2, the private address identifying uniquely each game machine 2 on the network 5 by being combined with the static address. In this case, a virtual private network (VPN) is configured between the game machine 2 and the center server 3 or between the game machines 2, and each game machine 2 is specified uniquely on the VPN by using the private address.

The center server 3 has also a function as a web server to provide service to a user terminal 7 which accesses the center server 3 via the network 5, as well as a function of providing various kinds of service to the game machine 2. The user terminal 7 corresponds to a user terminal apparatus. Any terminal apparatus may be applied to the user terminal 7, as long as the terminal apparatus is capable of connecting to a network such as a PC 7a and a portable phone 7b. Hereinafter, various kinds of terminal apparatuses such as the PC 7a and the portable phone 7b are not discriminated from each other, and each of them is represented as the user terminal 7.

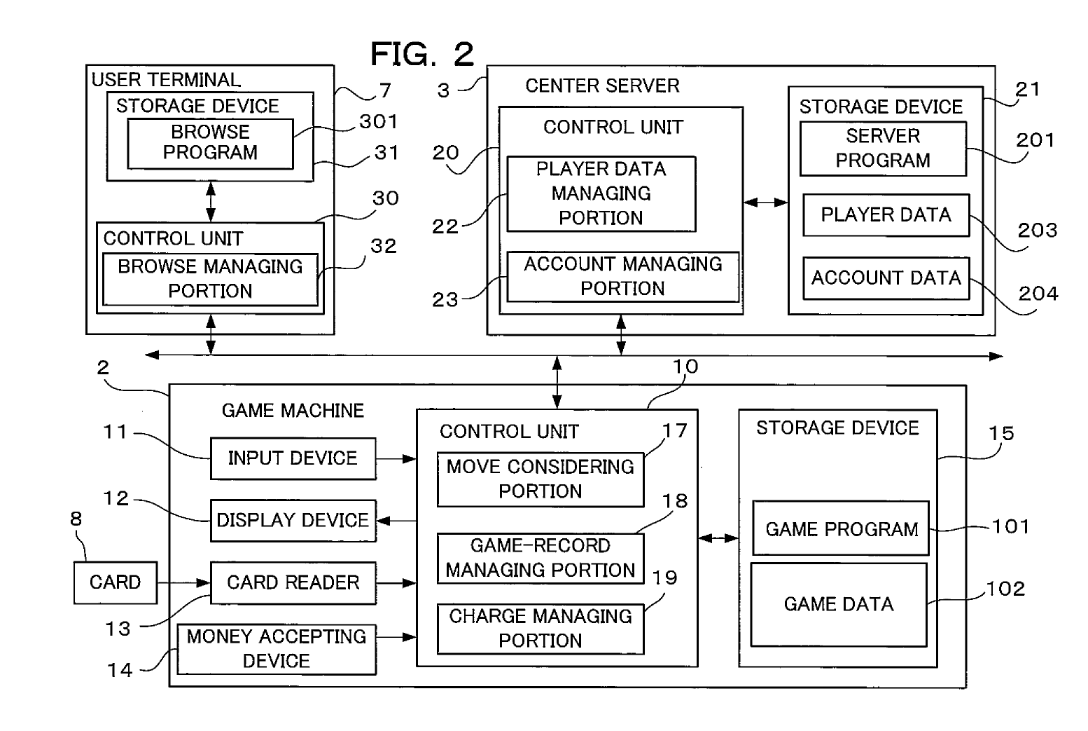

Next, in reference to FIG. 2, the further detail of the configuration of game system 1 will be described. First, the game machine 2 is provided with a control unit 10. To the control unit 10, an input device 11, a display device 12, a card reader 13, a money accepting device 14, and a storage device 15 are connected to. The input device 11 accepts an operation by a user, and outputs a signal depending on the operation content to the control unit 10. The display device 12 displays a game image and the like by following indications from the control unit 10. The card reader 13 reads out information of a card 8 held by a user and outputs a signal depending on the information to the control unit 10. The card 8 is provided with non-volatility storage medium such as an IC chip and a magnetic stripe (not illustrated) is mounted. An ID (hereinafter, sometimes is referred to as a card ID) unique for each card 8 and the like are recorded in the medium. The card ID may be recorded in the card 8 in a bar-code manner. The money accepting device 14 detects the value of money (coins or papers) input by a user, and outputs to the control unit a signal depending on the value of input. The storage device 15 is a storage device capable of holding memory such as a hard disk storage device. The storage device 15 holds a game program 101 for making the control unit 10 execute the Japanese chess game, and various kinds of game data 102 to which the game program 101 should refer.

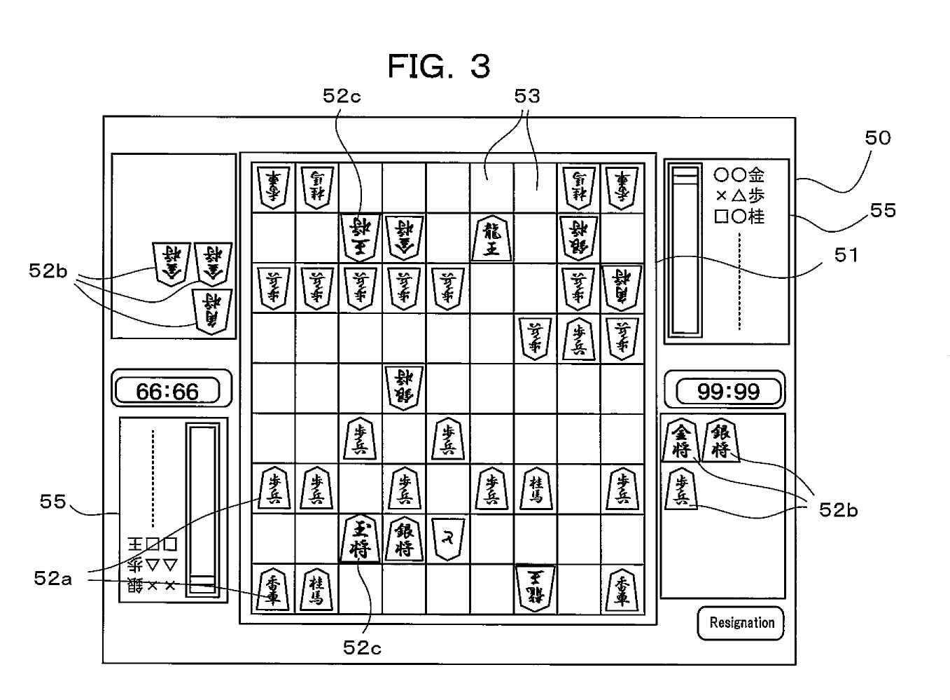

Here, the Japanese chess game which is executed at the game machine 2 will be explained referring to also a game image 50 shown in FIG. 3. In the Japanese chess, a playing turn is exchanged between two players, and the game is progressed in such a way that the player moves in each turn his/her piece 52a on a board face 51 which is sectioned in a grid-like, or allocates his/her piece 52b at a certain grid 53 on the board face 51, the piece 52b being held outside the board face. The action of the player in his/her turn is sometimes called “a move”. Hereinafter, though the pieces are discriminated from each other by means of an index such as a, b . . . depending on a situation, in a case where it is not necessary to discriminate each of them, each of the pieces is referred to as the piece 52.

Plural kinds are prepared as the piece 52. For each kind of piece 52, the motion direction and the motion amount (the number of grids) on the board face 51 are predetermined. By moving his/her piece 52a to the grid 53 where an opponent's piece 52a already exists, the player can obtain the opponent's piece 52a. Thereby, the player can hold the opponent's piece 52a obtained as the player's piece 52b. When the player moves his/her piece 52a to, or allocates his/her piece 52a on the grid where the player can obtain a piece 52c “O-shou” (or “gyoku-shou”) at the next turn, this situation is called “check”. A situation is called “checkmate” that the player can not remove the situation “check”. Each player moves his/her piece 52a to or allocates his/her piece 52b at a grid 53 on the board face 51 for the purpose of bringing the opponent's O-shou into the situation “checkmate”. In a case that any one of the players performs “check” to the opponent's O-shou and the O-shou is brought into the situation “checkmate”, the player wins the game and the game ends. As well as a case where the situation “checkmate” is confirmed, in a case where the player predicts his/her future situation on the game and it is apparent that the player's O-shou is moving into the situation “checkmate” earlier than the opponent's O-shou, the player admits his/her own defeat and can end the game. The situation that a player admits his/her own defeat and ends a game is called “resignation”. The game from the start to end thereof corresponds to one time of game-play. The record of the move of each turn from the start to end is the “game-record”. As shown in FIG. 3, in the game image 50, a move display portion 55 is provided. At the move display portion 55, the move in each turn of each player is displayed in a range from the latest turn to the turn going back a given number of times from the latest turn.

Returning to FIG. 2 and the explanation will be continued. The control unit 10 reads out and execute the game program 101 stored in the storage device 15 of the game machine 2. Thereby, in the inside of control unit 10, a move considering portion 17, a game-record managing portion 18, and a charge managing portion 19 are provided as logical devices. The move considering portion 17 obtains the board face of the Japanese chess game, and has a consideration routine which searches for moves (actions in the game) the user could select in each turn and calculates each of the moves quaontatively to determine which move is good or bad. The move considering portion 17 has a function of selecting as good moves, based on the value calculated by the consideration routine, moves existing within a predetermined rank from a move determined as the best move. The game-record managing portion 18 stores the moves of each player from the start to end of the game-play sequentially and thereby, generates a game record data set of each game-play. Namely, at the moment when one game-play ends, the game record data set where the moves within the game-play are recorded is generated in an internal storage device of the control unit 10 of the game machine 2. In addition, in the game record data set, moves determined as good moves for each playing turn by the move considering portion 17 are also recorded.

The charge managing portion 19 executes processes relating to the payment of game play fee, such as a request of the payment of game play fee to a user and a determination whether a requested value of the game play fee has been paid or not. In the present embodiment, as a payment means (a payment method) for the game play fee, the following two methods can be selected: one is a payment method by cash using the money accepting device 14; and another one is a payment method by withdrawing electronic money from an account managed by the center server 3. However, the minimum unit of payment value (the minimum value) in the payment method by electronic money is smaller than the one in the payment method by cash. For example, while the minimum unit in a case of paying by cash is 100 Japanese yen, in a case of electronic money, the payment is possible in units of one Japanese yen.

The center server 3 is provided with a control unit 20 and a storage device 21. The control unit 20 is a computer unit having a microprocessor and an internal storage device (not illustrated) comprising a ROM which holds programs to be executed by the microprocessor for an operating system and the like and a RAM which provides work areas for the microprocessor. Although an input device such as a keyboard and a display device such as a monitor are connected to the control unit 20, the illustrations of them are omitted. The storage device 21 holds a server program 201 to be executed by the control unit 20 and various kinds of data to which the server program 201 refers. In the storage device 21, player data 203 and account data 204 are stored as the data to which the control unit 20 should refer.

The player data 203 is data where information relating to game play content of a user is recorded in association with an ID (a user ID) unique for each user. The card ID and the user ID are correlated to each other on one-to-one or many-to-one. In the storage device 21 of the center server 3, data for discriminating the correlation between the IDs is also stored. The account data 204 is data where the value of electronic money a user possesses is recorded in association with the user ID. It is possible for the user to increase the value of electronic money held in the account data 204 (deposit) via a website and the like operated by the system operator and the like. With respect to the charge for the deposit of electronic money, the user is charged separately via a settlement means such as a credit card. Alternatively, electronic money may be deposited in exchange of cash by using a terminal intended for electronic money deposit or the like. The deposit and settlement of electronic money for the account data 204 can be similar to the deposit and settlement of prepaid type electronic money system, and the explanation of details thereof is omitted.

The control unit 20 reads out the server program 201 stored in the storage medium 21, and thereby a player data managing portion 22 and an account managing portion 23 are provided as logical devices inside of the control unit 20. The player data managing portion 22 implements processes necessary for providing a user with predetermined service based on the player data by following a request from the game machine 2 or the user terminal 7.

The account managing portion 23 is in charge of processes relating to management of electronic money account, such as a process of withdrawing a specified value of electronic money from the corresponding record of the account data 204 in response to the request to withdraw a fee from the game machine 2 or the user terminal 7. For example, in a case that a withdrawal process is requested with a card ID and a payment value from the game machine 2, the account managing portion 23 completes to pay the fee by electronic money in such a way that the account managing portion 23 specifies a record corresponding to the card ID from the account data 204, and subtracts the payment value from the value held in the record specified. A similar process is also implemented, in a case that a withdrawal process is requested with a card ID or a user ID and a payment value from the user terminal 7.

In the user terminal 7, a control unit 30 and a storage device 31 are mounted. The control unit 30 is a computer unit having a microprocessor and an internal storage device (not illustrated) comprising a ROM which holds programs to be executed by the microprocessor for an operating system and the like and a RAM which provides work areas for the microprocessor. Although an input device such as a keyboard and a display device such as a monitor are connected to the control unit 30, the illustrations of them are omitted. The storage device 31 stores a browse program 301 for making the control unit 30 implement various kinds of processes necessary for browsing the game record data set. The browse program 301 is stored in the storage device 31 by being downloaded from the center server 3 using a web-access function of the user terminal 7, or by being read out from a memory medium such as a CD and a DVD.

The control unit 30 reads out and executes the browse program 301 stored in the storage device 31. Thereby, in the inside of the control unit 30, a browse managing portion 32 as a logical device is provided. The browse managing portion 32 implements processes necessary for realizing browse of the game record data set in cooperation with the player data managing portion 22 of the center server 3. In the processes, a process for payment a counter value by electronic money in order to accept service from the center server 3 is also included. In each of the control unit 10 of the game machine 2, the control unit 20 of the center server 3 and the control unit 30 of the user terminal 7, various kinds of logical devices may be provided as necessary.

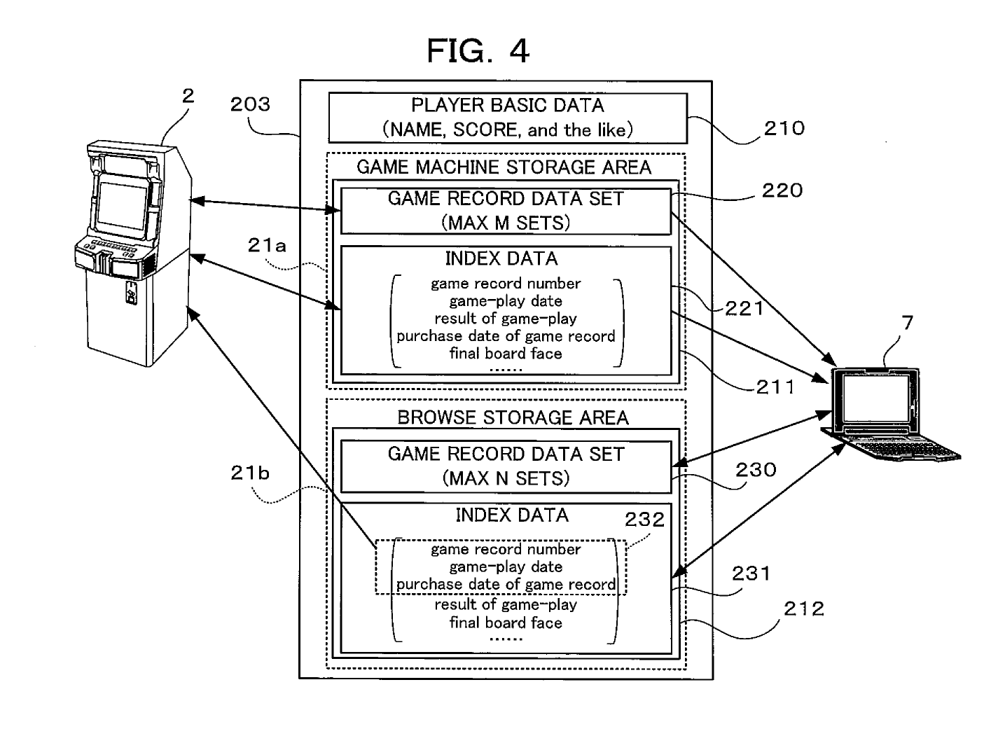

Next, referring to FIG. 4, there will be described the details of the player data 203 stored in the storage device 21 of the center server 3. The player data 203 shown in FIG. 4 is data stored in association with one user ID. The player data 203 includes player basic data 210, game machine data set 211, and browse data set 212. The player basic data 210 is data where information specifying a user such as user's name and information relating to basic game-play content such as user's score are correlated to each other. The player basic data 210 does not relate directly with the browse of the game record data set.

The game machine data set 211 is stored in a game machine storage area (a first storage area) 21a in the storage device 21. The game machine storage area 21a is set as an area where various kinds of data should be written for the game machine 2. In a case that the user terminal 7 accesses the game machine storage area 21a, it is possible to read out data from but impossible to write data into the game machine storage area 21a. The game machine data set 211 includes a game record data set 220 generated by the game machine 2 and index data set 221 corresponding to the game record data set 220. As mentioned above, the game record data set 220 is data where the moves included in one game-play are recorded sequentially by the game-record managing portion 18 provided in the control unit 10 of the game machine 2. It is possible to store up to M of game record data sets 220 in the game machine storage area 21a.

The index data 221 is identification information where features of a game record data set 220 is recorded for identifying the content of the game record data set 220. As one example, the index data 221 is generated as data where a game record number assigned uniquely for each game record data set 220 on one to one is correlated to the following data: the date of game-play (the game-play date) recorded in the game record data set 220; the result (the win or defeat) of game-play corresponding to the game record data set 220; the purchase date of the game record data set 220; the final board face and the like. The purchase date is the date when a user bought the game record data set 220. In order to browse (reproduce) at the user terminal 7 the game-play corresponding to the game record data set 220 stored in the game machine storage area 21a, a user is requested to “purchase” the game record data set 220 which the user wants to browse. The date when the game record data set 220 was purchased is recorded as the purchase date in the index data 221. With respect to a game record data set 220 which has not yet been purchased, in the information of the purchase date, null data is set or information indicating not purchase is recorded. A game record data set 220 where a date is recorded in the purchase date means that the game record data set 220 was already purchased. The final board face is a board face at the moment of end of game-play. It is necessary to pay a predetermined value of fee in order to purchase the game record data set 220. The purchase value is lower than the fee necessary for one game-play (the game-play fee). The payment of fee for purchasing the game record data set 220 is limited to a payment by electronic money.

The browse data set 212 is stored in a browse storage area (a second storage area) 21b in the storage device 21. The browse storage area 21b is provided in the storage device 21 as an area sectioned physically from the game machine storage area 21a. The browse storage area 21b is set as an area where various kinds of data should be written for the user terminal 7. In a case that the game machine 2 accesses the browse storage area 21b, it is possible to read out data from but impossible to write data into the browse storage area 21b.

The browse data set 212 includes game record data set 230 and index data 231 corresponding to the game record data set 230. The game record data set 230 is a copy of the game record data set 220 purchased by a user from the game record data set 220 stored in the game machine data set 211. In other words, the game record data set 230 is game-play data set which a user selects as a candidate for browse of the user terminal 7 through a concept of “purchase” from the game record data sets 220 stored in the game machine storage area 21a. It is possible to store up to N (N>M) game record data sets 230 in the browse storage area 21b. The index data 231 is identification information where features of a game record data set 230 is recorded for identifying the content of the game record data 230. As one example, the index data 231 is generated as data where a game record number assigned uniquely for each game record data set 230 on one to one is correlated to the following data: data where the date of game-play (the game-play date) recorded in the game record data set 230; the result (the win or defeat) of game-play corresponding to the game record data set 230; and the purchase date of the game record data set 230. The index data 231 is generated by adding, changing, or deleting predetermined information in the index data 221 corresponding to the game record data set 220 which is a copy source of the game record data set 230 corresponding to the index data 231. The game record number of the index data set 231 is equal to the game record number assigned to the game record data set 220 which is a copy source of the game record data set 230. The information of the game record number, the game-play date and the purchase date in the index data 231 are collected as purchase list data 232 which is recorded at the top of the index data 231. Incidentally, as any one of the game record data sets 230 has been already purchased, a certain date is always recorded in the purchase date of the index data 231.

It is set as shown by arrows in FIG. 4 whether accesses are allowed or not allowed from each of the game machine 2 and the user terminal 7 to the game machine data set 211 and the browse data set 212. Hereinafter, those accesses will be explained sequentially. With respect to access from the game machine 2 to the game machine storage area 21a, read-access and write-access to a game record data set 220 are allowed, and read-access and write-access to index data 221 are allowed. With respect to access from the game machine 2 to the browse storage area 21b, only read-access to the purchase list data 232 is allowed and both read-access and write-access are not allowed to access the other data. On the other hand, with respect to access from the user terminal 7 to the browse storage area 21b, read-access and write-access to a game record data set 230 are allowed, and read-access and write-access to index data 231 are allowed.

With respect to access from the user terminal 7 to the game machine storage area 21a, only read-access to a game record data set 220 and index data 221 is allowed, but write-access to a game record data set 220 and index data 221 is not allowed. Accordingly, in a case of the access from the game machine 2, it is possible to store a game record data set 220 and index data 221 only in the game machine storage area 21a. A game record data set 230 and index data 231 stored in the browse storage area 21b are never overwritten by the access from the game machine 2. Further, in a case of access from the user terminal 7, it is possible to store a game record data set 230 and index data 231 only in the browse storage area 21b. A game record data set 220 and index data 221 stored in the game machine storage area 21a are never overwritten by the access from the user terminal 7.

As mentioned above, the maximum number N which is the maximum game record data sets 230 that can be stored in the browse storage area 21b is bigger than the maximum number M which is the maximum game record data sets 220 that can be stored in the game machine storage area 21a. Namely, with respect to the storage of the game record data sets 220, 230, the storage capacity of the first storage area 21a is smaller than the storage capacity of the second storage area 21b. This is caused by the following reason. As the game machine 2 is a game machine for business use which is provided for commercial use, the game machine 2 is always in operation during the opening hour of a store or the like. The access from the game machine 2 to the server apparatus 3 occurs daily for the purpose of matching, charging and the like as well as communication of game record data sets. Because of this, the frequency of communication between the game machine 2 and the center server 3 is high, and the data traffic between them is big. As the number of the game machines connected to the center server 3 becomes more, this propensity becomes more noticeable. Accordingly, if the number of sets (pieces) of game record data set 220 which can be stored through the access from the game machine 2 increases, in association with this, the data traffic between the game machine 2 and the center server 3 increases noticeably, and thereby the load on the center server 3 enlarges extremely. Then, the number M of game record data sets 220 which can be stored through the access from the game machine 2 is limited to a relatively small value (as one example, 8). On the other hand, the user terminal 7 is not always in operation to access the center server 3 frequently like the game machine 2. The frequency of communication between the user terminal 7 and the center server 3 is lower in comparison with the frequency of communication between the game machine 2 and the center server 3. Accordingly, the number N of game record data sets 230 which can be stored in the browse storage area 21b is set as a relatively big value (as one example, 60). Thereby, it is possible to improve the browse service of the game record data set which is provided to the user terminal 7.

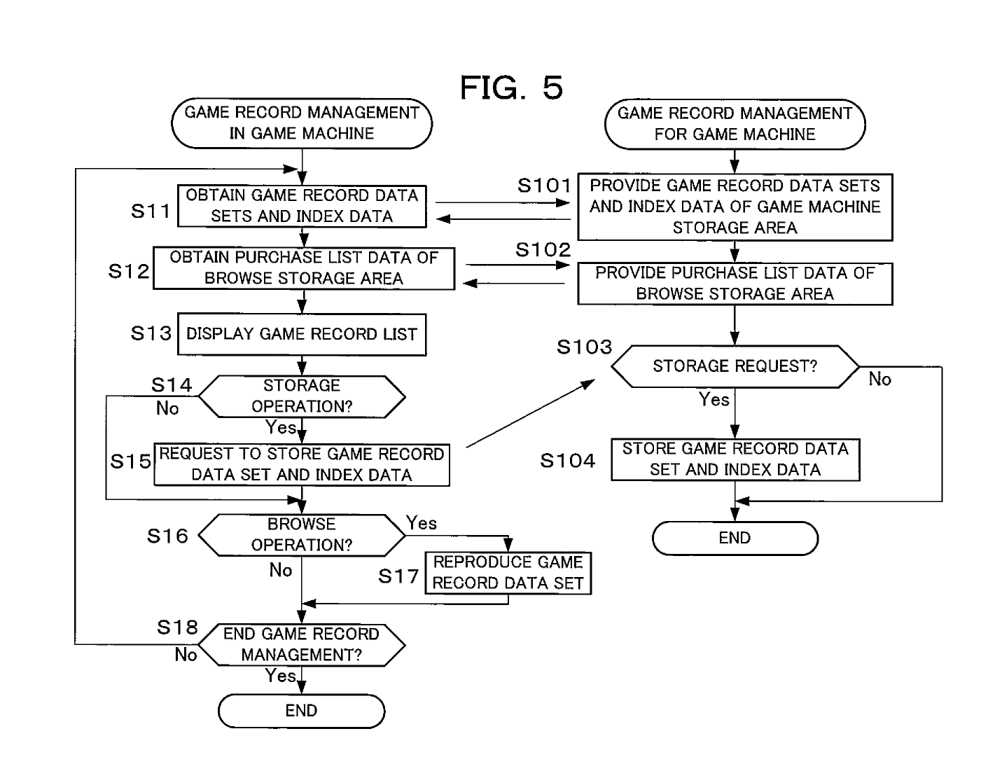

Next, there will be explained processes implemented by the control unit 10 of the game machine 2, the control unit 20 of the center server 3, and control unit 30 of the user terminal 7 respectively for enabling the browse of the game record data sets 220, 230. FIG. 5 shows a game record management in game machine routine to be implemented by the control unit 10 of the game machine 2, and a game record management for game machine routine to be implemented by the control unit 20 of the central server 3. When a user indicates a management of game record data set 220 (as one example, storage or browse of a game record data set 220) to the input device 11 of the game machine 2, the control unit 10 starts the routine shown in FIG. 5. At this moment, the user has made the control unit 10 recognize his/her card 8 via the card reader 13 of the game machine 2 to transmit the card ID to the center server 3 from the game machine 2, and thereby, the game machine 2 is capable of recognizing the user's card ID and the center server 3 is capable of specifying the player data corresponding to the card ID.

At the first step S11 of the routine shown in FIG. 5, the control unit 10 requests the center server 3 to transmit game record data sets 220 and plural pieces of index data 221 stored in the game machine storage area 21a. In response to this request, the control unit 20 of the center server 3 provides the game machine 2 with the game record data sets 220 and the plural pieces of index data 221 stored in the game machine storage area 21a in association with the user ID (step S101). The control unit 10 of the game machine 2 obtains the plural pieces of index data 221 provided from the center server 3. At subsequent step S12, the control unit 10 requests the center server 3 to transmit the purchase list data 232 stored in the browse storage area 21b. In response to this request, the control unit 20 of the center server 3 provides the purchase list data 232 correlated with the user ID (step S102), and the control unit 10 of the game machine 2 obtains the purchase list data 232 provided. At the next step S13, the control unit 10 displays a list of game record sets 220 (sometimes referred to as a game record list) stored in the game machine storage area 21a referring to the plural pieces of index data 221 and the purchase list data 232 obtained.

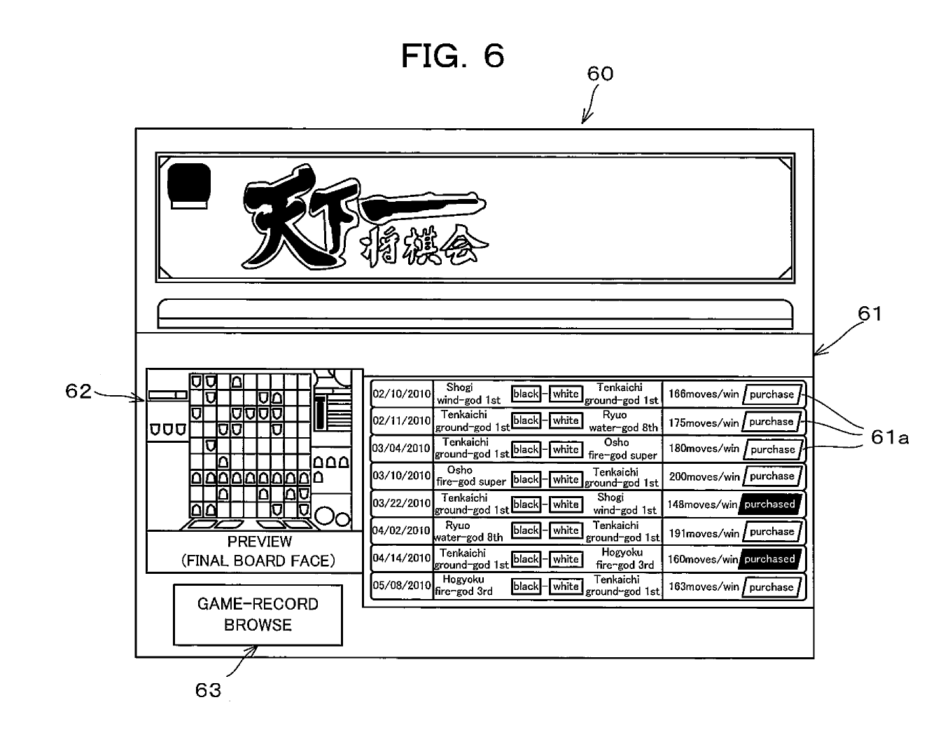

An example of the game record list is shown in FIG. 6. In a game-record list image 60 shown in FIG. 6, a list portion 61, a preview portion 62, and a game-record browse button 63 are shown. In the list portion 61, information indicating of outline of each of the game record data sets 220 stored in the game machine storage area 21a is shown in a list format (a view format). The information shown in the list portion 61 is based on the information held in the plural pieces of index data 221. For example, in the list portion 61, the information recorded in the index data 221, such as the game-play date and the game-play result of game record data set 220, is shown in a list format. The information of one line in the list portion 61 corresponds to one game record data set 220. Hereinafter, the one line of information is sometimes called as one record. At the last portion of each record in the list portion 61, the purchase information 61a is added, the purchase information 61a indicating whether the game record data 220 was purchased or not. At step S13, as one process of displaying the game record list, the control unit 10 determines whether the game record data set 220 was purchased or not referring to the index data 221 and the purchase list data 232, and controls to display the purchase information 61a by following the determination result. The user can recognize whether each game record data set 220 was purchased or not by referring to the purchase information 61a. The game record data set 220 which was purchased is a game record data set stored in both of the game machine storage area 21a and the browse storage area 21b. The game record data set 220 which has not yet been purchased is a game record data set stored in the game machine storage area 21a but not stored in the browse storage area 21b.

The maximum number of records which are displayed in the list portion 61 is M which is the maximum number of sets of game record data sets 220 which can be stored. The user of the game machine 2 can select through the input device 11 any one record from the records displayed in the list portion 61. When one record is selected in the list portion 61, the information of the final board face corresponding to the selected record is read out from the index data 221 and displayed in the preview portion 62. The game-record browse button 63 is a portion where the user clicks through the input device 11 for indicating to browse a game record data set 220 at the game machine 2, the game record data set 220 corresponding to the record selected in the list portion 61.

Returning to FIG. 5, the explanation will be continued. After making the display device 12 display the game-record list image 60, the control unit 10 goes to step S14. At step S14, the control unit 10 determines whether the user has performed to the input device 11a storage operation for storing a game record data set 220. At the moment of end of game-play, a game record data set generated by the game-record managing portion 18 of the control unit 10 is stored in the internal storage device of the control unit 10. When the user performs to the input device 11a predetermined storage operation, thereby, it is possible to store in the storage device 21 of the center server 3, a new game record data set which is stored in the internal storage device. At step S14, it is determined whether the storage operation has been performed or not. In a case that M game record data sets have been already stored in the game machine storage area 21a, it is necessary to overwrite any one of game record data sets with the new game record data set. In this case, the user can select a game record data set 220 which was purchased and indicate to overwrite the selected game record data set 220 with the new game record data set, referring to the purchase information 61a in the list portion 61 of the game-record list image 60. As the game record data set 220 which was purchased is copied and stored as the game record data set 230 in the browse storage area 21b, even though the game record data set 220 is overwritten with the new game record data set 220, the copied one is available for browse from the user terminal 7. In this embodiment, the term “overwrite” is used, in short, when the user selects in the game record list image 60 the game record data set 220 to be deleted in exchange of the storage of new game record data set, and performs the storage operation, the game record data set 220 which was purchased is overwritten with the new game record data set, and thereby, the game record data set 220 which was purchased is deleted. Namely, overwriting is used as one concept of deleting old data. The indication of overwriting may be available even in a state that the records the number of which is less than M are displayed in the game record list image 60.

In a case of determining that the storage operation has been performed at step S14, the control unit 10 goes to step S15 to generate index data 221 for the new game record data set 220 being stored in the internal storage device, and to transmit the game record data set 220 and the index data 221 to the center server 3 to request the center server 3 to store the game record data set 220 and the index data 221. The control unit 20 of the center server 3 monitors whether a storage request from the game machine 2 has been received or not after implementing the process of step S102 (step S103). When the storage request has, in response to the request, the control unit 20 stores the game record data set 220 and the index data 221 in association with the user ID in the game machine storage area 21a (step S104). The control unit 20 of the center server 3 ends the game record management routine of this time after storing the game record data set 220 and the like. When there is no storage request, the step S104 is skipped and the game record management routine in the center server 3 ends. The control unit 10 of the game machine 2 goes to step S16 after implementing the process of step S15. In a case that it is determined that there is no storage operation at step S14, the step S15 is skipped and the control unit 10 goes to step S16.

At step S16, the control unit 10 determines whether the user has performed to the input device 11a browse operation for browsing a game record data set 220. When the game-record browse button 63 in the list image 60 has been clicked, it is determined that the browse operation has been performed. When it is determined that the browse operation has been performed, the control unit 10 reproduces on the display device 12, based on the game record data set 220 selected in the list portion 61, a state of progressing game-play held in the game record data set 220. In this case, the game play from the start to end thereof may be reproduced sequentially by following the game record data set 220. Alternatively, the game play may be reproduced from a certain playing turn specified by the user. Additionally, as the game record data set 220 has been already obtained at step S11, at this stage, it is not necessary to obtain the game record data set 220 from the center server 3. Alternatively, the process may be configured such that the game record data set 220 is not obtained at the game machine 2 until the browse operation is performed at step S16, and at the moment when the process goes to step S17, the game record data set 220 as a browse target is obtained from the center server 3. In addition, when the game record data set 220 is obtained from the center server 3 at step S17, the reproduction may be started after all data of the game record data set is obtained, or the streaming reproduction is also available.

After reproducing the game record data set 220 at step S17, the control unit 10 goes to step S18. Also, in a case that it is determined whether the browse operation has not been operated at step S16, the control unit 10 goes to step S18. At step S18, the control unit 10 determines whether the user has indicated the end of the game record management. When the end of the game record management has not been indicated, the control unit 10 returns to step S11. When the end of the game record management has been indicated, the control unit 10 ends the routine of this time.

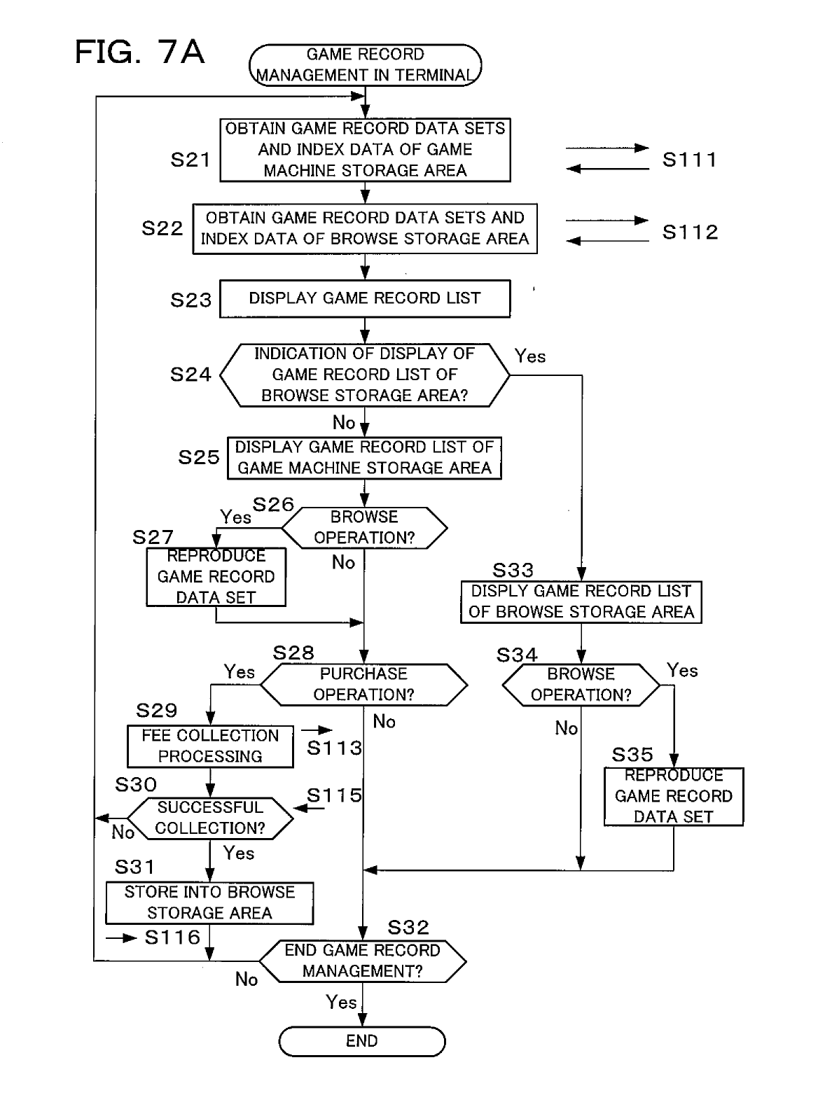

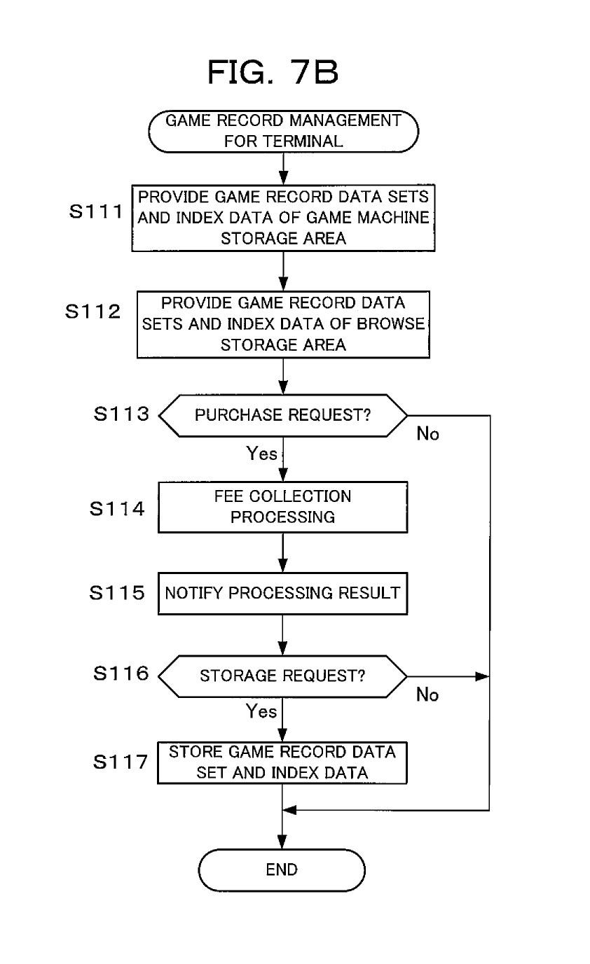

FIG. 7A shows a game record management in terminal routine implemented by the control unit 30 of the user terminal 7. FIG. 7B shows a game record management for terminal routine implemented by the control unit 20 of the center server 3 in response to the game record management in terminal routine. When the user indicates the management of game record (as one example, the purchase of game record data set 220 or the browse of game record data set 230) to the user terminal 7, the control unit 30 starts the routine shown in FIG. 7A. At this step the user input his/her card ID and user ID to the user terminal 7 to transmit the card ID and user ID from the user terminal 7 to the center server 3, and thereby, the user terminal 7 recognizes the card ID of the user, and the center server 3 is capable of specifying the player data corresponding to the card ID.

At the first step of step S21 in FIG. 7A, the control unit 30 requests the center server 3 to transmit game record data sets 220 and plural pieces of index data 221 stored in the game machine storage area 21a. In response to the request, the control unit 20 of the center server 3 provides the user terminal 7 with the game record data sets 220 and the plural pieces of index data 221 stored in the game machine storage area 21a in association with the user ID (step S11 in FIG. 7B). The control unit 30 of the user terminal 7 accepts the game record data sets 220 and the plural pieces of index data 221 provided by the center server 3. At subsequent step S22, the control unit 30 requests the center server 3 to transmit plural pieces of index data 231 stored in the browse storage area 21b. In response to the request, the control unit 20 of the center server 3 provides the user terminal 7 with the game record data sets 230 and the plural pieces of index data 231 stored in the browse storage area 21b in association with the user ID (step S112 in FIG. 7B). The control unit 30 of the user terminal 7 obtains the game record data sets 230 and the plural pieces of index data 231 provided. At subsequent step S23, the control unit 30 displays the game record lists in a game image corresponding to the game record data sets 220, 230 stored in the storage areas 21a, 21b, referring to the index data 221, 231 obtained, respectively.

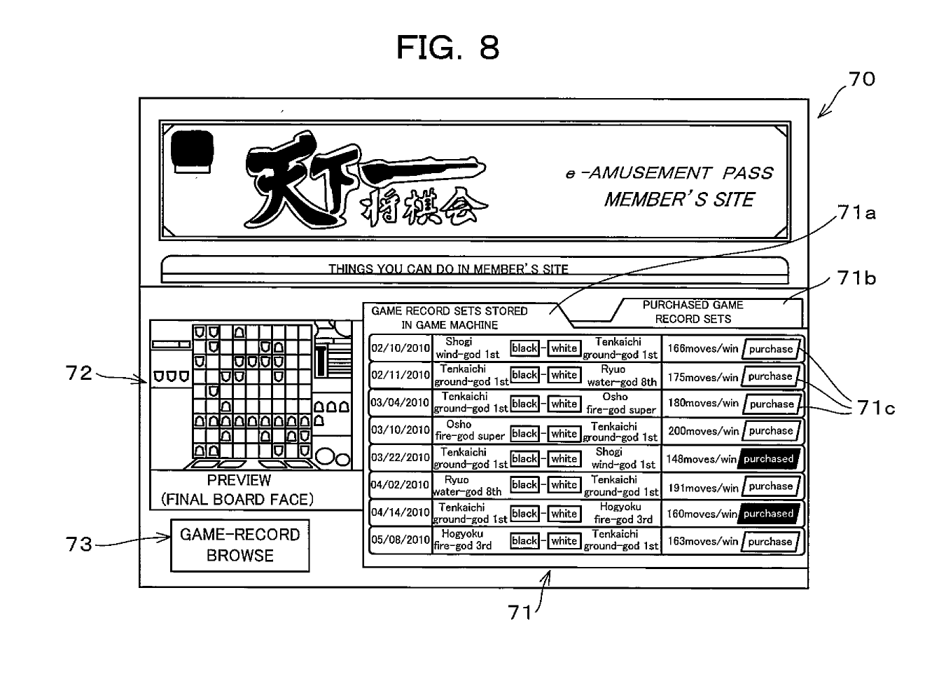

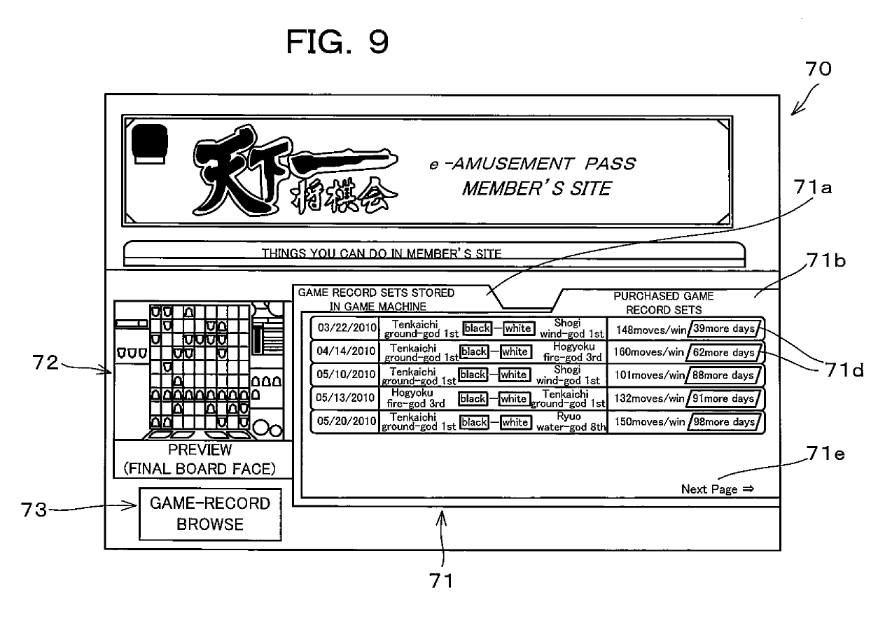

FIG. 8 shows an example of game record list displayed at the user terminal 7. In the game-record list image 70 shown in FIG. 8, a list portion 71, a preview portion 72 and a game-record browse button 73 are displayed. Although the list portion 71 is the almost same as the one of the game-record list image 60 shown in FIG. 6, as a different point, tabs 71a, 71b are displayed in the list portion 71 for selecting as a display target either one of a game record list based on plural pieces of index data 221 stored in the game machine storage area 21a or a game record list based on the plural pieces of index data 231 stored in the browse storage area 21b. The user can display in the list portion 71 either one of the game record list (FIG. 8) based on the index data 221 or the game record list (FIG. 9) based on the index data 231 by clicking either one of the tab 71a or tab 71b. In an initial state, the game record list based on the index data 221 is displayed.

The game record list shows various kinds of information corresponding to the index data 221, 231 in a list format (a view format), similarly to the game record list shown in FIG. 6. However, in the game record list (FIG. 8) corresponding to the index data 221, in place of the purchase information 61a of FIG. 6, a purchase button 71c is shown for indicating purchase of game record data set 220 which is stored in the game machine storage area 21a and plus has not yet been purchased. It is determined whether or not each game record data set 220 has been purchased, by comparing information of the index data 221 to information of the purchase list data 232. With respect to a game record data set 220 which was purchased, in place of the purchase button 71c, information indicating that the game record data set 220 was purchased. At step S23, as one of processes for displaying the game record list, the control unit 30 determines whether or not each game record data set 220 has been purchased by comparing the index data 221 to the purchase list data 232, and controls to display the purchase button 71c depending on the result of determination.

In a state that the image shown in FIG. 8 is displayed, the user of the user terminal 7 can indicate the purchase of game record data set 220 by clicking any one of the purchase buttons 71c. As shown in FIG. 9, in the game record list image 70 corresponding to the index data 231, in place of the purchase information 61a of FIG. 6, browse time limit information 71d for each game record data set 230 is displayed. The user is permitted to browse a game record data set 230 until a predetermined time limit from the purchase date. The control unit 30 refers to the purchase date held in the index data 231 and calculates the remaining dates until the browse time limit for each game record data set 230, and displays the remaining dates calculated in the browse time limit information 71d. In addition, in a case that the number of game record data sets 230 exceeds the number available to be displayed in one image of the list portion, the game record list corresponding to the index data 231 is constructed so that the records thereof are divided into plural pages and displayed through the pages. In the list portion 71, provided is a page change operation portion 71e for changing the pages. Incidentally, the user can select any one of the records displayed in the list portion 71. The information of final board face corresponding to the record selected in the list portion is read out from the index data 221, 231 and displayed in the preview portion 72. The game-record browse button 73 is an operation portion for indicating to browse at the user terminal 7 the game record data set 220, 230 corresponding to the record selected in the list portion 71.

Returning to FIGS. 7A and 7B, explanation will be continued. When the game record list is displayed at step S23 in FIG. 7A, the control unit 30 goes to step S24 to determine whether or not there is an indication to display the game record list based on the index data 231 of the browse storage area 21b, depending on whether or not the tab 71b has been clicked. If there is not the indication, the control unit 30 goes to step S25 to display the game record list based on the index data 221 stored in the game machine storage area 21a. In a case that the game record list has been already displayed, the display is continued. At successive step S26, the control unit 30 determines whether or not the browse operation has been performed at the user terminal 7, that is, the game-record browse button 73 has been clicked in the game-record list image 70 of FIG. 8. In a case that the browse operation has been performed, the control unit 30 goes to step S27. At step S27, based on the game record data set 220 corresponding to the record selected in the list portion 71 of FIG. 8, the control unit 30 reproduces on the display device of the user terminal 7, the state that the game-play held in the game record data set 220 is progressed. Also in this case, as the game record data set 220 has been already obtained at step S21, it is not necessary to obtain the game record data set 220 from the center server 3. However, the process may be also configured such that the game record data set 220 is not obtained until the browse operation is performed at step S26, and at the moment when the process goes to step S27, the game record data set 220 as a browse target is obtained from the center server 3. With respect to the reproduction of game record data set 220, the game play from the start to end thereof may be reproduced sequentially by following the game record data set 220. Alternatively, the game play may be reproduced from a certain playing turn specified by the user. Further, in a case that the game record data set 220 is obtained from the center server 3 at step S27, after all data of the game record data set 220 is downloaded, the reproduction may be started, or the streaming reproduction is also available. Furthermore, the system may be configured such that it is impossible to browse at the user terminal 7, game record data sets 220 of the game machine storage area 21a by omitting steps S26, S27.

When the reproduction is ended at step S27 or it is determined at step S26 that the browse operation has not been performed, the control unit 30 goes to step S28. At step S28, the control unit 30 determines whether or not a purchase operation has been performed, that is, any one of the purchase buttons 71c of the game record list has been clicked. In a case that the purchase operation has been performed, the control unit 30 goes to step S29 to implement the process for collecting a fee which is a counter value for the purchase of the game record data set 220, in cooperation with the control unit 20 of the center server 3. The control unit 20 of the center server 3 goes to step S113 after implementing step S113, to determine whether or not fee collection processing has been requested from the user terminal 7. In a case that an affirmative determination is obtained, at step S114, it is tried to withdraw electronic money the value of which is set as the counter value for the purchase of game record data set 220 from the account data 204 corresponding to the user ID. Then, at step S115, the result of the fee collection processing, that is, whether or not the withdrawal is successful is notified to the user terminal 7.

After implementing step S 29, the control unit 30 of the user terminal 7 goes to step S30 to determine whether or not the collection of purchase value of the game record data set 220 is successful based on the result of fee collection processing notified from the center server 3. In a case of successful, the control unit 30 goes to step S31 to request the center server 3 to store the game record data set 220 purchased and the index data 221 corresponding to the game record data set 220 in the browse storage area 21b. In this step S31, the control unit 30 while providing the game record data set 220 purchased to the center server 3, records the purchase date in the index data 221 corresponding to the game record data set 220 and after the record, provides the index data 221 to the center server 3. After notifying the result of processing at step S115 of FIG. 7B, the control unit 20 of the center server 3 determines whether or not there is a storage request for the game record data set 220 and the like from the user terminal 7. In a case that there is the storage request, the control unit 20 goes to step S117 to store the game record data set 220 and the index data 221 provided from the user terminal 7 in the browse storage area 21b as the game record data set 230 and the index data 231 respectively. In addition, in a case that the maximum number N of game record data sets 230 have been already stored in the browse storage area 21b, it is necessary to delete any one of game record data sets 230 and, in place of the game record data set 230 deleted, store a new game record data set 220 in the browse storage area 21b. In this case, the user may be asked to specify any one piece of game record data sets 230 as a deletion target.

In addition, with respect to the storage of the game record data set and the index data in steps S31 and S117, as the game record data set 220 has been already accepted by the user terminal 7, the process is not limited to the example that the game record data set 220 is transmitted to the center server 3 and stored in the browse storage area 21b. The system may be configured such that: information specifying the game record data set 220 as a purchase target is provided from the user terminal 7 to the center server 8 and it is indicated to the center server 3 to make a copy of the game record data set 220 to the browse storage area 21b; in response to the indication, the center server 3 makes a copy of the game record data set 220 to the browse storage area 21b from the game machine storage area 21a. Similarly, also with respect to the index data 221, the data 221 may be copied from the game machine storage area 21a to the browse storage area 21b. However, in this case, it is necessary that the center server 3 adds the purchase date to the index data 221.

After the game record data set 220 and the like are stored in the browse storage area 21b at step S31 of FIG. 7A, the control unit 30 of the user terminal 7 goes back to step S21. On the other hand, in a case that it is determined at step S28 that the purchase operation has not been performed, the control unit 30 goes to step S32. At step S32, the control unit 30 determines whether or not the user has not indicated the end of game record management. In a case that the end has not been indicated, the control unit 30 returns to step S21. In a case that the end has been indicated, the control unit 30 ends the routine of this time. The control unit 20 of the center server 3 stops the routine of FIG. 7B after storing the game record data set 220 and the like at step S117. In a case that it is determined at step S113 that there is no purchase request, or it is determined at step S116 that there is no storage request, the control unit 20 stops the routine of FIG. 7B.

In a case that it is determined at step S24 of FIG. 7A that it has been indicated to display the game record list based on the index data 231 of the browse storage area 21b, the control unit 30 of the user terminal 7 goes to step S33. At step S33, the control unit 30 displays on the user terminal 7, the game-record list image (FIG. 9) corresponding to the index data 231 of the browse storage area 21b. At successive step S34, the control unit 30 determines whether or not the browse operation has been performed at the user terminal, that is, whether or not the game-record browse button 73 has been clicked in the game-record list image 70 of FIG. 9. In a case that the browse operation has been performed, the control unit 30 goes to step S35.

At step S35, the control unit 30 reproduces on the display device of the user terminal, the state that the game-play recorded in the game record data set 230 is progressing based on the game record data set 230 corresponding to the record selected in the list portion 71 of FIG. 9. Here, the game record data set 230 which is used for reproduction corresponds to game-play data set selected as a browse target by the user. Even when the browse is implemented at step S35, as the game record data sets 230 have been already obtained at step S22, it is not necessary to obtain the game record data set 230 from the center server 3. However, the process may be configured such that the game record data set 230 is not obtained until the browse operation is performed at step S34, and at the moment when the process goes to step S35, the game record data set 230 of the browse target is obtained from the center server 3. With respect to the reproduction of the game record data set 230, the game-play from the start to end thereof may be reproduced sequentially by following the game record data set 230. Alternatively, the game-play may be reproduced from a certain playing turn specified by the user. Further, in a case that the game record data set 230 is obtained from the center server 3 at step S35, after all of the game record data set 230 is downloaded, the reproduction may be started, or the streaming reproduction is also available. In a case that the reproduction is ended at step S35, or in a case that it is determined the browse operation has not been performed at step S34, the control unit 30 goes to step S32. The process in the step S32 has been already described.

As explained above, in the game system 1, the game machine storage area 21a and the browse storage area 21b are provided in the storage device 21 of the center server 3, and the game record data set 220 generated based on the game-play in the game machine 2 is stored in the game machine storage area 21a. And, the game system 1 allows the user to select at the user terminal 7, the game record data set as a candidate for browse at the user terminal 7 from the game record data sets 220 stored in the game machine storage area 21a, and stores the selected game record data set in the browse storage area 21b. Further, the game system 1 allows the user to select at the user terminal 7, the game record data set 230 as the browse target from the game record data sets 230 stored in the browse storage area 21b, and uses the selected game record data set 230 for browse of the game-play.

Accordingly, even if the storage capacity of the game machine storage area 21a, in other words, the number of game record data sets 220 that can be stored in the storage area 21a is restricted in consideration of the load on the center server 4 due to accesses from the game machines 2, even in a case, after a game record data set 220 is stored as a game record data set 230 in the browse storage area 21b, the game record data set 220 corresponding to the game record data set 230 is deleted from the storage area 21a, there is no problem to browse the game-play at the user terminal 7. Further, when the access from the user terminal 7 to the center server 3 is limited, the storage capacity of the browse storage area 21b, in other words, the number of game record data sets 230 that can be stored in the browse storage area 21b is expanded, the load on the center server 3 increases not so much. In this way, the storage areas 21a, 21b are provided so as to be separated from each other. Thereby, while it is possible to set the game storage area 21a in accordance with the accesses or the like from the game machine 2 to the center server 3, it is possible to set the browse storage area 21b in accordance with the accesses or the like from the user terminal 7 to the center server 3. Thereby, it is possible to provide appropriate service to the game machine 2 and the user terminal 7 respectively, while the load increase of server being suppressed.

In addition, the game system 1 also performs the following effects. Two pieces of index data 221, 231 as identification information are stored in the storage areas 21a, 21b respectively, like the game record data sets 220, 230. Accordingly, also with respect to these pieces of data 221, 231, it is possible to treat the data 221, 231 similar to the game record data sets 220, 230 respectively.

The game record data set 220 and the index data 221 are written into the first storage area 21a in response to the request from the game machine 2, and the game record data set 230 and the index data 231 are written into the second record area 21b in response to the request from the user terminal 7. The data in the first storage area 21a is never rewritten by an access from the user terminal, or, the data in the second storage area 21b is never rewritten by an access from the game machine 2. Therefore, it does not occur that, by accesses from both of the game machine 2 and the user terminal 7, data competes against each other, or data becomes inconsistent. Further, in a case that data stored in one of the storage areas is moved, or the storage area is maintained, it is not necessary to be concerned about any affection given to data stored in the other storage area. Accordingly, the restriction with respect to data management is also reduced.

When the user is allowed to select a game record data set 220 as a candidate for browse at the user terminal 7, the list of game record data sets 220 based on the index data 221 stored in the game machine storage area 21a and the list of game record data sets 230 based on the index data 231 stored in the game machine storage area 21b are presented to the user (FIG. 8 and FIG. 9). Thereby, it is possible for the user to select easily the game record data set 220 which should be stored in the browse storage area 21b as the candidate for browse. Additionally, by displaying the purchase button 71c in the game-record list image 70, the user can specify further easily a game record data set 220 which has not yet been purchased, that is, game-play data set which is stored in the game machine storage area 21a but not stored in the browse storage area 21b.

Incidentally, in order to display the lists of game record data sets 220, 230 stored in the storage areas 21a, 21b, it is not always required that the index data 221, 231 is generated and stored in advance. For example, at the moment when the game-record list image 70 is displayed, it is possible to analyze the game record data sets 220, 230 and generate the list. However, by generating the index data 221, 231 in advance, the list display can be realized easily and promptly, and it is possible to reduce the load on the system required for implementing the processes.

The game record data sets 220 and the index data 221 are obtained at the user terminal 7, the game record data set and the index data selected as the candidate for browse are transmitted from the user terminal 7 to the center server 3, and the transmitted data is stored in the browse storage area 21b. Accordingly, it is not necessary that the center server 3 extracts the selected game record data set 220 and the selected index data 221. Thereby, the load on the center server 7 can be reduced.

At the moment when a game record data set 220 is stored in the game machine storage area 21a, the game record data sets 220 stored in the storage area 21a are presented in a list format to the user through the game-record list image 60 (FIG. 6). Accordingly, the user can recognize the storage situation of the game record data sets 220 by the game-record list image 60 and can select a game record data set 220 to be deleted from the storage area 21a the capacity of which is limited. Further, as the game machine 2 refers to the purchase list data 232 stored in the browse storage area 21b and compares the purchase list data 232 to the index data 221 at the moment when the game-record list image 60 is displayed, it is possible to easily recognize within the game record data sets 220 displayed in the game-record list image 60, a game record data set 220 which was purchased, that is, the game record data set 220 which is stored in the browse storage area 21b. Thereby, the user can further easily specify the game record data set 220 to be deleted. Incidentally, the purchase list data 232 is obtained by excerpting from the index data 231, one part information necessary for determining whether or not each game record data set was purchased or not. Accordingly, the amount of data communication for the game machine 2 to obtain the purchase list data 232 is smaller in comparison with a case that whole of the index data 231 is provided to the game machine 2. Thereby, it is possible to reduce the communication amount between the game machine 2 and the center server 3 relating to the storage of the game record data set 220, and reduce the load on the center server 3.

The fee payment by electronic money is requested at the moment when a game record data set 220 is purchased, and if the fee is not paid, it is forbidden to store a game record data set 230 into the browse storage area 21b (step S30 in FIG. 7A). Accordingly, it is possible to collect through the network 5, a counter value required for the browse service and allow the user to easily use the browse service, while maintaining the consistency of the conception that the game itself is the service with fee which is provided as a counter value of the game-play fee. AS the payment by electronic money is available for small value payment, flexible fee setting is possible in accordance with the content of browse service. Namely, though the game-play fee should be set originally as a counter value for game-play itself, if the browse service is presented without fee, it becomes necessary to collect the costs and the like for the browse service in the game-play fee. Therefore, the fairness of load is not maintained between the user using the browse service and the user not using the browse service. On the other hand, as the browse service is service following basic service such as game-play, it is preferable to set the fee of browse service lower than the game-play fee. Then, by setting the fee collection by electronic money appropriate for small value payment as one required condition, it is possible to collect the counter value appropriate for the browse service. Incidentally, the counter value for purchase of game record data set may be collected by using various kinds of electronic fee collection methods of collecting a fee by exchange of electronic payment information such as payment using credit card information, in place of, or in addition to the payment by electronic money.

In the above embodiment, the control unit 20 of the center server 3 functions as a first game-play data storing device by implementing step S104 in FIG. 5, and function as a second game-play data storing device by implementing step S117 in FIG. 7B. By cooperating the control unit 20 of the center server 3 and the control unit 30 of the user terminal 7, a candidate for browse selecting device, a browse target for terminal selecting device, and a browse for terminal implementing device are realized. Namely, the control unit 20 of the center server 30 provides to the user terminal 7 the game record data sets 220, 230 and the index data 221, 231 at steps S111 and S112 in FIG. 7B, and the control unit 30 of the user terminal 7 obtains those data at steps S21 and S22 in FIG. 7A, and displays the game-record list image 70 at steps S23 to S25 and S33. Thereby, the presentation of list (71) is realized. In addition, the control unit 30 determines the purchase operation at step 28 and S31 and while providing the purchased game record data set 220, requests the center server 3 to store the purchased game record data set 220. Thereby, the candidate for browse selecting device is realized. The control unit 20 of the center server 3 provides to the user terminal 7 game record data sets 230 and plural pieces of index data 231 at step S112 in FIG. 7B, and the control unit 30 of the user terminal 7 obtains those data at step S22 of FIG. 7A, and displays the game-record list image 70 based on the plural pieces of index data 231 at step S33. Thereby the presentation of list (71) is realized. Further, the control unit 30 determines the browse operation at step S34. Thereby, the browse target for terminal selecting device is realized. Then, the control unit 20 of the center server 3 provides the game record data sets 230 at step S112, and at step S35 reproduces the content of game-play based on the game record data set 230 selected as the browse target. Thereby, the browse for terminal implementing device is realized. Also, with respect to each step constituting the invention of method for controlling browse, the step is realized like the above mentioned way.

In the above embodiment, each of the index data 221 and 223 corresponds to identification information and the control unit 10 of the game machine 2 and the control unit 30 of the user terminal 7, which generates such identification information, functions as an identification information generating device. Then, the control unit 20 functions as a first identification information storing device by storing the index data 221 at step S104, and functions as the second identification information storing device by storing the index data 231 at step S117.

In the above embodiment, by cooperating the control unit 10 of the game machine 2 and the control unit 20 of the center server 3, a deletion data selecting device, a browse target for game apparatus selecting device, and a browse for game apparatus implementing device are realized. Namely, the control unit 20 of the center server 3 provides the index data 221 and the purchase list data 232 at steps S101 and S102 in FIG. 5 respectively, and the control unit 10 of the game machine 2 obtains those data at steps S11 and S12 and presents the game-record list image 60 at step S13. Thereby, the presentation of the list 61 of the game record data sets 220 to the user is realized. The control unit 10 accepts the specification of the overwriting target at step S14. Thereby, the deletion data selecting device is realized. Further, the control unit 20 of the center server 3 provides game record data sets 220 and plural pieces of index data 221 at step S101, and the control unit 10 of the game machine 2 obtains those data at step S11 and determines whether or not the browse operation has been performed at step S16. Thereby, the browse target for game apparatus selecting device is realized. And, the control unit 20 of the center server 3 provides game record data sets 220 at step S101, and the control unit 10 of the game machine 2 obtains the game record data sets 220 at step S11 and reproduces the game record data set 220 selected as the browse target. Thereby, the browse for game apparatus implementing device is realized.

In the above embodiment, the control unit 20 of the center server 3 implements withdrawal of a fee from the account data 204 by using the account managing portion 23. Thereby, an electronic fee collecting device is realized. The control unit 30 of the user terminal 7 functions as a storage controlling device by implementing steps S29 and S30 in FIG. 7A.

The present invention is not limited to the above mentioned embodiment and can be implemented as various kinds of embodiments. For example, the game record data set 220, 230 is not obtained at the moment when the game record list image 60, 70 is displayed, but at the moment when the browse is indicated, the data set 220, 230 may be provided from the center server 3 to the game machine 2 and the user terminal 7. The game record data set 220 is not limited to an example that is generated at the game machine 2, and the center server 3 may generate the game record data set 220 by recording operation history of the game machine 2. Also, with respect to the index data 221, the center server 3 may analyze the game record data set 220 transmitted from the game machine 2 to generate the index data 221. In a case that the center server 3 generates the game record data set 220, the center server 3 may generate the index data 221. Also, with respect to the index data 231, the center server 3 may generate the index data 231 in a similar way to the index data 221. In a case that, under a situation where the user terminal 7 obtains a game record data set 220 and index data 221 stored in the game machine storage area 21a (that is, a situation where the processing in FIG. 7 is progressing after implementing steps S21 and S111), it is indicated to store, update, or the like the game record data set 220 of the same user ID at the game machine 2, it could happen that the game record data set 220 and the index data 221 which are being referred become not the latest data. However, even in such a case, as the game record data set 220 and the index data 221 have been already accepted by the user terminal 7, it is possible to store those data 220, 221 in the browse storage area 21b.

The game record data sets 220, 230 may be at least based on the same game-play content, and the formats of the data 220, 230 may be different from each other so as to be appropriate for each of the game machine 2 and the user terminal 7. Further, the game record data set 230 may be generated by extracting one part of the game record data set 220. In the above embodiment, the storage number M of the game record data sets 220 for the game machine 2 is smaller than the storage number N of the game record data sets 230 for the user terminal 7. However, for example, in a case that the communication frequency from the user terminal 7 to the center server 3 is higher than the communication frequency from the game machine 2 to the center server 3, such modification may be applied as the storage number M of game record data sets 220 is made bigger than the storage number N of game record data sets 230. Alternatively, also in a case that the processing power of the user terminal 7 is lower the one of the game machine 2 and there is a limitation of data amount of the game record data set 230 which can be implemented by the user terminal 7, the storage number N is made smaller than the storage number M. Alternatively, such modification may be applied as the game record data set 230 is generated as simplified game record data set 220.

In the above embodiment, as one example of browse, the game-play of Japanese chess is reproduced based on the game record data set 230 (or 220). However, the conception of browse is not limited to this example. The browse can be realized in such a way that the game-play content is displayed in a list format or a text format. Further, the game-play data set is not limited to data like the game record data set where selection or action by a user is recorded for each playing turn, and may be applied as long as at least one part of the game-play content is recorded in any format in the data. For example, the game-play data set can be generated by recording game images.

The game-play data set that a user can browse is not limited to game-play data set based on game-play contents of the same user. For example, in a case a particular user intends to open to the public, his/her game-play data set where his/her game-play contents are recorded, the intention may be added to the game-play data set, that is, information indicating permission of open to the public is added to the game-play data set. Then, with respect to the game-play data set with the permission, the system may be configured so that any user can “purchase” the game-play data set as the candidate for browse and browse the data set.

In the preset invention, the game to be applied is not limited to the Japanese chess game, and any game can be applied depending on the situation. Each of the game apparatus and the user terminal is also limited to the above example, and can be modified depending on the situation. For example, by setting a portable phone, a game machine for home use or the like as the game apparatus, the game apparatus may be set as a user terminal apparatus PC. The game apparatus may be configured so as to be also used as the user terminal apparatus, by mounting a mode for operating as the user terminal apparatus to the game apparatus and switching selectively between a mode for operating as the original game apparatus and the mode for operating as the user terminal apparatus.

1. A game system using a server apparatus connected to a game apparatus via a network, allowing a user to play a predetermined game, recording at least one part of game-play content of the game in a game-play data set to store the game-play data set in the server apparatus, and enabling the user to browse the game-play content corresponding to the game-play data set at a user terminal apparatus connected to the server apparatus via the network, the game system comprising:
a game-play storage device provided to the server apparatus, and adapted and configured to have a first storage area set as a writing area for the game apparatus and a second storage area set as a writing area for the user terminal apparatus;
a first game-play data storing device adapted and configured to store the game-play data set into the first storage area by following an indication from a user of the game apparatus;
a candidate for browse selecting device adapted and configured to present a list of game-play data sets stored in the first storage area to a user of the user terminal apparatus, and allow the user to select a game-play data set to be a candidate for browse from the game-play data sets stored in the first storage area;
a second game-play data storing device adapted and configured to store the game-play data set selected as the candidate for browse into the second storage area;
a browse target for terminal selecting device adapted and configured to present a list of game-play data sets stored in the second storage area to the user of the user terminal apparatus, and allow the user to select a game-play data set to be a browse target from the game-play data sets stored in the second storage area; and
a browse for terminal implementing device adapted and configured to provide the game-play data set selected as the browse target to the user terminal apparatus, and allow the user of the user terminal apparatus to browse the game-play content corresponding to the game-play data set provided.

2. The game system according to claim 1, wherein
the candidate for browse selecting device is adapted and configured to further present a list of game-play data sets stored in the second storage area to the user, and allow the user to select the game-play data set to be the candidate for browse.

3. The game system according to claim 1 or 2, further comprising:
an identification information generating device adapted and configured to generate identification information for identifying the content of the game-play data set;
a first identification information storing device adapted and configured to, caused by storing the game-play data set into the first storage area, store the identification information corresponding to the game-play data set into the first storage area; and
a second identification information storing device adapted and configured to, caused by storing the game-play data set selected as the candidate for browse into the second storage area, store the identification information corresponding to the game-play data set into the second storage area.

4. The game system according to claim 3, wherein
the candidate for browse selecting device is adapted and configured to provide the identification information stored in the first storage area to the user terminal apparatus, and present the list of game-play data sets stored in the first storage area to the user of the user terminal apparatus.

5. The game system according to claim 4, wherein
the second identification information storage device is adapted and configured to obtain from the use terminal and store into the second storage area, the identification information corresponding to the game-play data set selected as the candidate for browse.

6. The game system according to claim 3, wherein
the candidate for browse selecting device is adapted and configured to further present to the user a list of game-play data sets stored in the second storage area by providing the identification information stored in the second storage area to the user terminal apparatus, and allow the user to select the game-play data set to be the candidate for browse.

7. The game system according to claim 3, wherein
the candidate for browse selecting device is adapted and configured to further present to the user, information for the user to specify a game-play data set which is stored in the first storage area and not stored in the second storage area, based on the identification information stored in the first storage area and the identification information stored in the second storage area.

8. The game system according to claim 1, wherein
the candidate for browse selecting device is adapted and configured to provide the game-play data sets stored in the first storage area to the user terminal apparatus, and
the second game-play data storing device is adapted and configured to obtain from the user terminal apparatus and store into the second storage area the game-play data set selected as the candidate for browse.

9. The game system according to claim 3, further comprising a deletion data selecting device adapted and configured to present a list of game-play data sets stored in the first storage area to the user of the game apparatus, based on the identification information stored in the first storage area, and allow the user to select a game-play data set to be deleted from the first storage area in exchange of a storage of a new game-play data set by the first game-play data storing device, wherein
the first game-play data storing device is adapted and configured to store the new game-play data set into the first storage area in exchange of a deletion of the game-play data set selected by the deletion data selecting device.

10. The game system according to claim 9, wherein
the deletion data selecting device is adapted and configured to further present to the user, information for the user to specify a game-play data set which is stored in the first storage area and not stored in the second storage area, based on the identification information stored in the first storage area and the identification information stored in the second storage area.

11. The game system according to claim 1 wherein, the game-play data set is generated in the game apparatus, and the first game-play data storing device is adapted and configured to obtain the game-play data set from the game apparatus and store the game-play data set into the first storage area.

12. The game system according to claim 1, comprising:
a browse target for game apparatus selecting device adapted and configured to present a list of game-play data sets stored in the first storage area to the user of the game apparatus, and allow the user to select a game-play data set to be the browse target from the game-play data sets stored in the first storage area; and
a browse for game apparatus implementing device adapted and configured to allow the user of the game apparatus to browse the game-play content corresponding to the game-play data set selected as the browse target.

13. The game system according to claim 1, wherein
the game apparatus is configured as a game machine for business use which allows game-play in exchange of a payment of game-play fee.

14. The game system according to claim 13, wherein
a storage capacity of the first storage area for the game-play data set is smaller than a storage capacity of the second storage area for the game-play data set.

15. The game system according to claim 13, further comprising:
an electronic fee collection device adapted and configured to collect a fee by exchange of electronic payment information; and
a storage controlling device adapted and configured to, for a storage of the game-play data set into the second storage area, request the user to pay a predetermined fee through the electronic fee collection device, and permit the storage of the game-play data set into the second storage area in a case that the predetermined fee is paid, and restrict the storage of the game-play data set into the second storage area in a case that the predetermined fee is not paid.

16. A method for controlling browse of game-play content being applied to a game system using a server apparatus connected to a game apparatus via a network, allowing a user to play a predetermined game, recording at least one part of game-play content of the game in a game-play data set to store the game-play data set in the server apparatus, and enabling the user to browse the game-play content corresponding to the game-play data set at a user terminal apparatus connected to the server apparatus via the network, the method including the following steps:
providing a game-play storage device to the server apparatus, and adapted and configured to have a first storage area set as a writing area for the game apparatus and a second storage area set as a writing area for the user terminal apparatus;
storing the game-play data set into the first storage area by following an indication from a user of the game apparatus;
presenting a list of game-play data sets stored in the first storage area to a user of the user terminal apparatus, and allowing the user to select a game-play data set to be a candidate for browse from the game-play data sets stored in the first storage area;
storing the game-play data set selected as the candidate for browse into the second storage area;
presenting a list of game-play data sets stored in the second storage area to the user of the user terminal apparatus, and allowing the user to select a game-play data set to be a browse target from the game-play data sets stored in the second storage area; and
providing the game-play data set selected as the browse target to the user terminal apparatus, and allowing the user of the user terminal apparatus to browse the game-play content corresponding to the game-play data set provided.
